(19) United States
(12) Patent Application Publication
(10) Pub. No.: US 2011/0234753 A1
(43) Pub. Date: Sep. 29, 2011

(54) SYSTEM FOR ENCODING AND DECODING STEREOSCOPIC IMAGES

(75) Inventors: Antonio Caramelli, Roma (IT); Stefano Tabarelli De Fatis, Schio (IT)

(73) Assignee: 3DSWITCH S.R.L., Roma (IT)

(21) Appl. No.: 13/124,309

(22) PCT Filed: Sep. 4, 2009
(86) PCT No.: PCT/IB2009/006761

§ 371 Date: Jun. 16, 2011

(30) Foreign Application Priority Data
Oct. 21, 2008 (IT) MO2008A000267

(51) Int. Cl. H04N 13/00

(52) U.S. Cl. 348/43; 348/E13.062

(57) ABSTRACT

A system and a method for encoding and decoding stereoscopic images are described. A stereoscopic image comprises at least two sub-images arranged according to a first configuration and intended for a user's right eye and left eye, respectively. During the video signal post-production stage, a chromatic code is embedded which in adapted to provide information about said configuration. At receiver level, decoding means (14) are used which are adapted to receive said stereoscopic image, recognise the configuration of said at least two sub-images based on information embedded into said stereoscopic image, and arrange said at least two sub-images according to a second predetermined configuration.

### DESCRIPTION

The invention relates to a system for encoding and decoding stereoscopic images forming a single video stream. Tests for transmitting tridimensional stereoscopic images were first carried out in the twenties by John Logie Baird, who used a system based on a double-spiral Nipkow disk.

In later years, many other tests were carried out and different techniques were developed for displaying stereoscopic images.

Some examples of such experimented video transmission techniques are those called “anaglyphic” (based on two complementary colours, e.g. red and green), “Pulfrich effect” (based on moving a video camera always in the same direction), “time separation” (where frames for the user's left eye are alternated with frames for the user's right eye), and “two separated channels” (one for the user's left eye and the other for the user's right, eye).

In said first tests, the stereoscopic images were captured live, since it was not yet possible to record a video stream; only in later times were recording and playback techniques used for this purpose.

The distribution of video streams having tridimensional contents has so far been dependent on bidimensional television standards and on the type of display system employed. The best commercial results have been obtained by using “time separation” systems, wherein the lines of a composite video signal are encoded half for one eye (even lines) and half for the other eye (odd lines). For watching tridimensional contents, liquid crystal shutter glasses are used.

With the advent of computers, of high-resolution bidimensional systems and of the Internet, the stereoscopic format scenario has expanded in different directions, but with a few common denominators. In fact, in most cases the information about both eyes are encoded into a single video stream. Within the latter, each stereoscopic image As subdivided into two sub-images, so that the set of images intended for a user's eye forms a first sub-stream of the video stream, and the set of images intended for the other eye forms a second sub-stream of the same video stream.

No reference standard is currently known for the information about, for example, position, size, rotation and layout of the tridimensional images in the video stream. Nor is any encoding mode currently known which allows to decipher how the two video sub-streams are organised, within the whole video stream.

Therefore, a decoder device having to interface the video stream with a display system cannot automatically extract the information about the two stereoscopic video sub-streams.

It follows than decoding the images forming the two stereoscopic video sub-streams requires a user to act upon the decoder device (based on supplementary information not encoded in the video stream or through visual inspection) for the purpose of determining how the decoding should be done.

It is an object of the invention to improve the systems for encoding and decoding stereoscopic images.

It is another object to provide a system for encoding and decoding stereoscopic images which does not require a user to act upon a decoder device in order to allow a corresponding display system to display stereoscopic images correctly.

These and other objects of the present invention are achieved through a method and a system for encoding stereoscopic images, as well as a method and a system for decoding such images when received in a single video stream.

According to the invention, a system is provided for transmitting and receiving stereoscopic images carried in a single video stream.

The system is characterized by comprising encoding means that comprise a protocol which can be embedded into portions of said stereoscopic images, said protocol comprising information about said stereoscopic images, in particular about the mode (or configuration) in which the sub-images for the right and left eyes are arranged within the stereoscopic image.

Therefore, the encoding means embed into the stereoscopic images a code carrying information about such images, in particular about the sub-image layout.

For the stereoscopic image, the code embedded by the encoding means is equivalent to a stamp (or protocol) through which a document can be identified; therefore, in the following description it will be referred to without distinction as code or protocol.

Such a code embedded into the image becomes independent of the standard and encoding used, as well as of the format in which the image is transmitted to the receiver.

Stereoscopic images are currently transmitted and stored according to different configurations. For example, the two images intended for the user's right eye and for the user's left eye may be encoded into a single stereoscopic image by subdividing the latter horizontally into two sub-images, each containing the image intended for one eye; alternatively, the single image may be subdivided vertically into two portions.

Among other things, the code (or protocol) according to the present invention also allows to know which of these configurations has been applied to the stereoscopic image.

The image may without distinction be stored into an optical medium (e.g. Compact Disc or DVD or Blu-ray) and then be reproduced by a suitable player, or else it may be broadcast to receivers, e.g. through any DVB (Digital Video Broadcast) standard; in any case, the code (or protocol) of the stereoscopic image, since it has been embedded into the image itself, is always available to the receiver/player which is to read and/or decode it, thus being independent of the way in which the image is generated, stored, compressed, encoded, transmitted, received or reproduced.

On the receiver side, the system comprises decoding means adapted to decode said information about said stereoscopic images based on said embedded protocol, so as to format said stereoscopic images in a manner which is compatible with the display device.

The invention provides a system for encoding and decoding stereoscopic images which does not require a user to act upon a decoder device in order to allow a corresponding display system to display stereoscopic images correctly. In fact, the system can interpret the supplementary information contained in the video stream and pertaining to the manner in which the stereoscopic images are structured in the video stream or to the video stream type, i.e. if the video stream contains bidimensional or tridimensional images.

With this information, which is suitably arranged by the encoding means, the decoding means can handle the video stream and send it to a display device, such as a tridimensional television set.

In other words, once the stereoscopic image has been received (broadcast or read by means of a player) by the decoding means, the latter will use the code (or protocol) embedded into the image in order to decode it and allow it to be converted, if necessary, and displayed correctly.

In particular, a stereoscopic image consists of at least two sub-images (one for the right eye and one for the left eye), and the information carried by the code (or protocol) embedded into the image may concern the configuration of these two sub images; in particular, it may indicate if the sub-images are arranged side by side, up-down, rotated, etc.

Because of the code embedded into the image, the decoding means understand know how the sub-images are arranged within the stereoscopic image and can distinguish them; thus, according to the display device in use (e.g. a micropolarization LCD television set or a tridimensional back-projection DLP television set), the two sub-images are formatted appropriately, i.e. composed into a given format.

Furthermore, it is also possible to obtain a highly reliable encoder system for low data transmission speeds with a small number of identifier elements, i.e. elements forming the encoding code. The code is encoded in a manner such that it can also be interpreted by a human operator, if necessary, in addition to the decoder means.

The encoding and decoding system is compatible with small image sizes and high compression rates for use over the Internet.

The invention can be better understood and implemented by referring to the annexed drawings showing an exemplifying, non-limiting version thereof, herein:

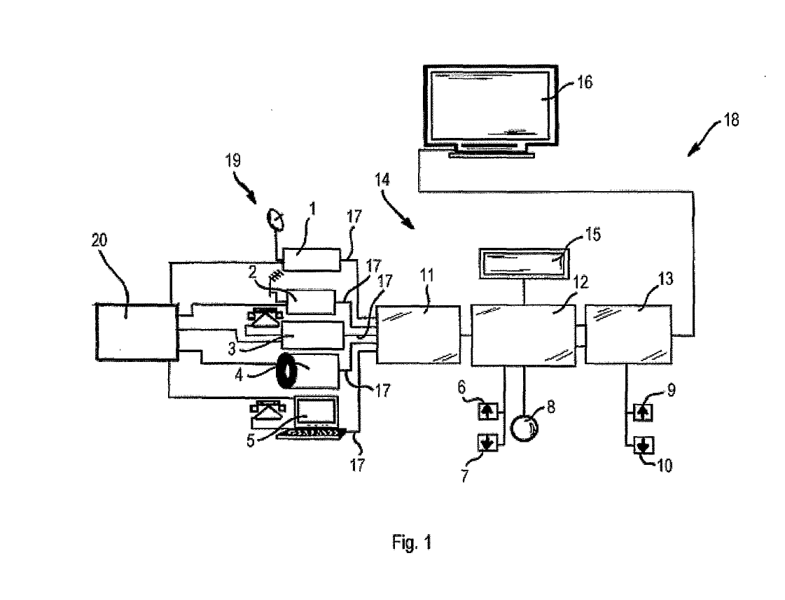

FIG. 1 is a schematic view of a system for encoding and decoding stereoscopic images according to the invention;

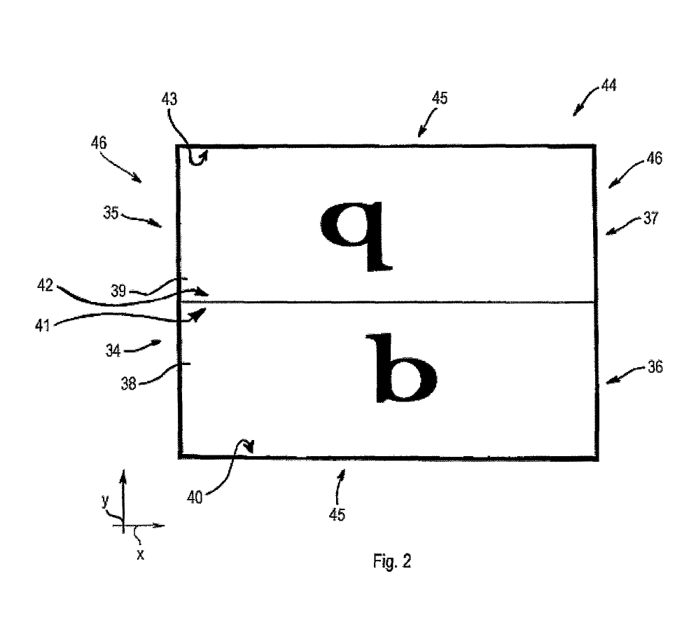

FIG. 2 is a schematic view of a stereoscopic image comprising two sub-images;

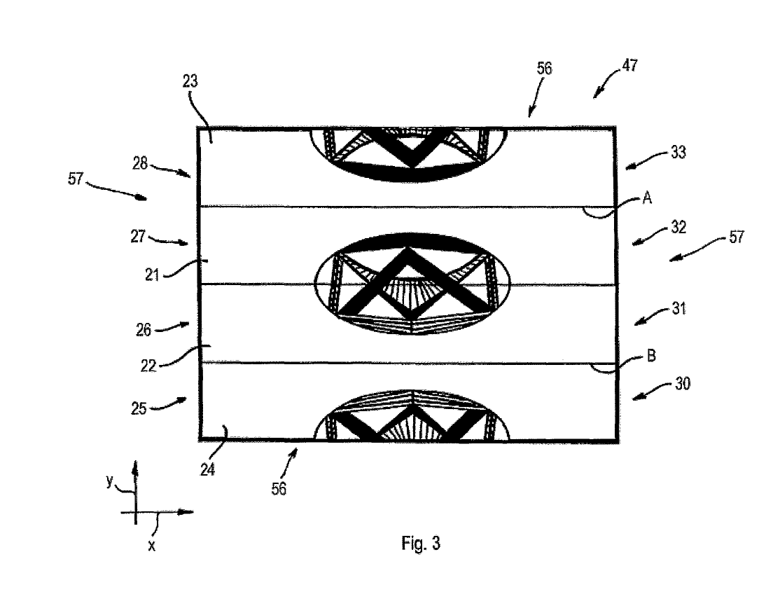

FIG. 3 is a schematic view of a stereoscopic image comprising four sub-images.

FIG. 1 shows a system 18 for encoding and decoding stereoscopic images.

The system 18 is adapted to receive a video stream, e.g. carried by a cable 17, comprising stereoscopic (tridimensional) images and possibly also bidimensional images.

The video stream may come from image transmission means 19, which may for example include: a satellite decoder 1, an analog or digital terrestrial signal receiver 2, a cable television adapter 3, a reader device 4 for reading optical devices such as Digital Versatile Discs (DVD), Blu-Ray Discs (BRD) or the like, or a computer 5.

In this frame, the term “transmission means” refers to any device capable of outputting a video stream, in particular of the type comprising a stereoscopic image.

When it comprises stereoscopic images, the video stream can be subdivided into two stereoscopic sub-streams.

One sub-stream comprises images intended for a user's eye, while the other sub-stream comprises sub-images intended for the other user's eye.

The sub-images within a stereoscopic image may be two or any multiple of two.

The two sub-images can be organized within a stereoscopic image in a plurality of manners, thereby obtaining different configurations. The different configurations depend on the layout of the sub-images within the stereoscopic image. In fact, the sub-images may have a side-by-side or up-down layout. The different configurations also depend on the arrangement of the sub-images intended for the user's left eye relative to those intended for the user's right eye. Finally, the different configurations depend on any geometric transformations that the sub-images may be subjected to. In fact, all or some sub-images may be rotated and/or reflected and/or overturned along axes parallel to the sides of the stereoscopic image.

The system 18 comprises encoding means 20 (shown schematically as a rectangle) and decoding means 14. The encoding means 20 comprise information about the type of images forming the video stream and the configuration of the sub-images in the stereoscopic image.

The encoding means 20 comprise a protocol adapted to interface the image transmission means 19 with the decoding means 14.

The protocol uses a chromatic code (which will be explained more in detail later on), which allows said information to be encoded.

In the embodiment described herein, the protocol comprises a plurality of data sequences inserted based on the chromatic code. The data sequences extend at least along a line located above and/or under the stereoscopic image and having the same width as the image.

The protocol is embedded Into the stereoscopic images during the video post-production stage by using a specific software program or a part of a suitable video editing software package. As an alternative, it may be superimposed by using suitable devices similar to titlers.

The encoding means 20 that encode the stereoscopic image, i.e. that define the image identification code (or protocol), are therefore generally separate from the transmission means 19.

In FIG. 1, said encoding means 20 are shown connected to the transmission means 19 only to indicate that the code embedded by them into the stereoscopic image is found in the video signal stored in a medium (such as a DVD) which is read by the reader 4 or by the computer 5, or in the video signal received by the receivers 1, 2 and 3.

The various sequences included in the protocol contain specific information and perform specific functions, such as:

a) protocol start identification for a video stream containing stereoscopic images subdivided each into a plurality of sub-images;

b) arrangement of the sub-images within the stereoscopic image (side by side or up-down, i.e. vertical or horizontal division);

c) arrangement of the sub-images intended for the user's left eye relative to those intended for the user's right eye;

d) mutual arrangement of the sub-images;

e) sub-image rotation and/or reflection and/or overturning;

f) free portion available for further protocol expansions;

g) protocol end identification for a video stream containing stereoscopic images subdivided (each) into a plurality of sub-images.

The protocol is based on the three fundamental colours (red, green, blue), the white colour (combination of the three fundamental colours) and the black colour.

The protocol comprises a plurality of mutually alternated chromatic elements, called “colour elements” and “basic elements”.

Colour elements may have the following colours: red, green, blue, white or black.

Basic elements may only be white.

The basic elements are interposed between the colour elements in the protocol in order to improve the latter's readability.

The width of the elements is correlated to the horizontal width of the stereoscopic image. In fact, in order to define the width of the basic element, the total width of the stereoscopic image is divided by a predetermined number, e.g. 128.

Each colour element is twice as wide as the basic element; therefore, if the width of each basic element is 1/128, the width of each colour element will be 1/64 of the total width of the stereoscopic image.

Alternatively, the width of each colour element may be a whole multiple of the width of the basic elements.

Thus, due to alternated colour and basic elements, the protocol will comprise in succession, for example, a basic element having a width of 1/128 (of the total width), a colour element having a width of 1/64, another basic element having a width of 1/128, another colour element having a width of 1/64, and so on along the whole width of the stereoscopic image.

This allows to obtain 42 colour elements alternated with as many basic elements. In order to complete the total width of the stereoscopic image, two basic elements are inserted at the end of the protocol, so as to cover the entire width of the stereoscopic image. The following formula is thus obtained:

42×2+Δ+2=128

where:

42×2 are the colour elements, the width of which is twice as that of the basic elements;

42 are the basic elements;

2 are the basic elements at the end of the protocol.

Starting from the international convention on the arrangement of navigation lights of boats and/or aircraft (red light on the left, green light on the right), in the protocol according to the invention the red and green colours identify the left and right sub-images, respectively. Moreover, the protocol utilizes the blue colour for identifying the upper portion of a sub-image, whereas black identities the lower portion of a sub-image.

At least one portion of the sequences of chromatic elements may comprise a succession of colour elements and basic elements recalling colour sequences included in national flags.

A specific meaning is associated with each colour element, which meaning depends (as will be described below) on the position of the colour element within the protocol.

When a stereoscopic image is subdivided into two sub-images, e.g. a lower sub-image and an upper sub-image, the protocol will comprise sequences containing specific information and having specific functions:

a) protocol start identification for a video stream containing stereoscopic images subdivided (each) into two sub-images;

b) arrangement of the two sub-images within the stereoscopic image (side by side or up-down, i.e. vertical or horizontal division);

c) arrangement of the sub-image intended for the user's left eye relative to the sub-image intended for the user's right eye;

d) sub-image rotation and/or reflection and/or overturning;

e) free portion available for further protocol expansions;

f) protocol end identification for a video stream containing stereoscopic images subdivided (each) into two sub-images.

The protocol start identification sequence for a video stream containing stereoscopic images subdivided (each) into two sub-images comprises a sequence of colour elements alternated with white basic elements.

The sequence of colour elements of the protocol start identification sequence for a video stream containing stereoscopic images subdivided (each) into two sub-images may comprise the green colour, the red colour and the blue colour in succession.

The protocol start identification sequence for a video stream containing stereoscopic images subdivided (each) into two sub-images thus comprises a white basic element (having a width equal to 1/128 of the total width of the stereoscopic image), a green colour element (having a width equal to 1/64 of the total width of the stereoscopic image), a white basic element (having a width equal to 1/128 of the total width of the stereoscopic image), a red colour element (having a width equal to 1/64 of the total width of the stereoscopic image), a white basic element (having a width equal to 1/128 of the total width of the stereoscopic image), a blue colour element (having a width equal to 1/64 of the total width of the stereoscopic image) and, lastly, a white basic element (having a width equal to 1/128 of the total width of the stereoscopic image).

Colour elements also comprise white separator elements, each having a width equal to 1/64 of the total width of the stereoscopic image. The separator element is therefore a colour element having a white colour. A separator element is placed at the end of the sequences listed above.

Being repeated regularly every 3/128 of the total width of the stereoscopic image, and being also used as a separator element, the white colour improves protocol readability in both cases where the protocol is to be decoded by the decoding means 14 and where it has to be decoded by a user.

As a fourth element (of the total 42), a white separator element is inserted after the protocol start identification sequence for a video stream containing stereoscopic images.

The sequence indicating the arrangement of the two sub-images within the stereoscopic image is then inserted into the protocol, which sequence is adapted to transform into colour elements the information indicating whether the sub-images of the stereoscopic image have a side-by-side layout (vertical division of the stereoscopic image) or an up-down layout (horizontal division of the stereoscopic image). In fact, one colour element, e.g. blue, identifies a horizontal division, whereas another colour element, e.g. red, identifies a vertical division.

At the end of the sequence indicating the arrangement of the two sub-images within the stereoscopic image, another white separator element is inserted into the protocol which precedes the sequence indicating the arrangement of the sub-image intended for the user's left eye relative to the sub-image intended for the user's right eye.

The sequence indicating the arrangement of the sub-image intended for the user's left eye relative to the sub-image intended for the user's right eye comprises two colour elements. This is based on the fact that the red colour element is associated with the concept of what is located on the left (and is therefore associated with a user's left eye), while the green colour element is associated with the concept of what is located on the right (and is therefore associated with the user's right eye).

FIG. 2 shows a horizontally divided stereoscopic image 44 comprising a lower sub-image 38 containing information intended for the user's left eye and an upper sub-image 39 containing information intended for the user's right eye.

In order to establish whether the sequence indicating the arrangement of the sub-image 38 relative to the sub-image 39 comprises the green colour element followed by the red colour element or vice versa, the system 18 performs a scan along an X axis or a Y axis depending on the type of division detected. The X axis is parallel to a major side 45 of the stereoscopic image 44, whereas the Y axis is parallel to a minor side 46 of the stereoscopic image 44. Since the division of the stereoscopic image 44 is horizontal, the scan will take place from bottom to top along the Y axis. The sub-images found during the scan will determine the colour of the colour elements to be inserted into the protocol. Should the division be vertical, the scan would take place from left to right along the X axis. In the case of the stereoscopic image 44, the two colour elements to be inserted in succession are a red colour clement and a green colour element.

This is because the scan carried out along the Y axis first finds the lower sub-image 38, intended for the user's left eye (associated with the rod colour element), followed by the upper sub-image 39, intended for the user's right eye (associated with the green colour element).

In the case of a protocol which can be used for displaying a video stream of stereoscopic images subdivided into pairs of sub-images, another white separator element is inserted into the protocol at the find of the sequence indicating the arrangement of the sub-image intended for the user's left eye relative to the sub-image intended for the user's right eye.

This separator element precedes the sub-image rotation and/or reflection and/or overturning sequence.

The sub-image rotation and/or reflection and/or overturning sequence defines a sequence of colour elements that provide information useful for knowing if the sub-images are rotated and/or reflected and/or overturned relative to the stereoscopic image to be displayed.

By convention, it is established that the left side of the stereoscopic image corresponds to the red colour element, the right side corresponds to the green colour element, the upper side corresponds to the blue colour element, and the lower side corresponds to the black colour element.

In order to be able to establish which colours are to be embedded, it is necessary to carry out a double scan, first along the X axis and then along the Y axis, thus verifying which sides of the stereoscopic image to be displayed are referred to by the sides of the sub-images.

In the case of the horizontally divided stereoscopic image 44, wherein the upper sub-image 39 is rotated by 180°, based on the scan performed along the X axis it will be necessary to embed into the protocol, in succession, a red colour element, a green colour element, another green colour element, and another red colour element.

This is because, starting from the lower left corner (starting point of the scan along the X axis) of the stereoscopic image 44, the following will be encountered in succession:

a left side 34 of the lower sub-image 38, corresponding to the left side of the stereoscopic image to be displayed;

a left side 35 of the rotated upper sub-image 39, corresponding to the right side of the stereoscopic image to be displayed;

a right side 36 of the lower sub-image 38, corresponding to the right side of the stereoscopic image to be displayed;

a right side 37 of the rotated upper sub-image 39, corresponding to the left side of the stereoscopic image to be displayed.

Subsequently, based on the result of the scan along the Y axis, a black colour element, a blue colour element, another blue colour element, and another black colour element will be inserted into the protocol.

This is because, starting from the bottom of the stereoscopic image 44, the following will be encountered in succession:

a lower side 40 of the lower sub-image 38, corresponding to the lower side of the stereoscopic image to be displayed;

an upper side 41 of the lower sub-image 38, corresponding to the upper side of the stereoscopic image to be displayed;

a lower side 42 of the rotated upper sub-image 39, corresponding to the upper side of the stereoscopic image to be displayed;

an upper side 43 of the rotated upper sub-image 39, corresponding to the lower side of the stereoscopic image to be displayed.

Consequently, because of the double scan performed, the sub-image rotation and/or reflection and/or overturning sequence comprises two sub-sequences, one for each scan and each consisting of four colour elements, separated by a white separator element.

A free portion sequence may be inserted into the protocol for possible further protocol expansions, at the end of which a white colour element is inserted.

The protocol ends with a protocol end identification sequence for a video stream containing stereoscopic images.

The protocol end identification sequence for a video stream containing stereoscopic images may be identical to the protocol start sequence for a video stream containing stereoscopic images, i.e. it may comprise a white basic element, a green colour element, a white basic element, a red colour element, a white basic element, a blue colour clement and, lastly, a white basic element.

If the stereoscopic image is subdivided into two sub-images, the sequence indicating the mutual arrangement of the sub-images is absent. This is because there are only two sub-images, and the information about their mutual arrangement is already included in the sequence indicating the arrangement of the two sub-images within the stereoscopic image.

As aforementioned, the protocol is also applicable to video streams containing stereoscopic images subdivided into more than two sub-images, e.g. four sub-images (two of which are intended for the user's right eye and the other two are intended for the user's left eye).

The sequences forming the protocol contain specific information and perform specific functions also when the stereoscopic image is subdivided into four sub-images:

a) protocol start identification for a video stream containing stereoscopic images subdivided (each) into four sub-images;

b) arrangement of the four sub-images within the stereoscopic image (side by side or up-down, i.e. vertical or horizontal division);

c) arrangement of the sub-images intended for the user's left eye relative to those intended for the user's right eye;

d) mutual arrangement of the four sub-images;

e) sub-image rotation and/or reflection and/or overturning;

f) free portion available for further protocol expansions;

g) protocol end identification for a video stream containing stereoscopic images subdivided (each) into four sub-images.

The protocol start identification sequence for a video stream containing stereoscopic images subdivided (each) into four sub-images may be the same as the protocol start identification sequence for a video stream containing stereoscopic images subdivided (each) into two sub-images. Consequently, it may comprise, in succession, a white basic element, a green colour element, a white basic element, a red colour element, a white basic element, a blue colour element and, lastly, a white basic element.

In this case as well, a separator element, e.g. white, is placed at the end of each sequence listed above.

A white separator element is thus inserted after the protocol start sequence for a video stream containing stereoscopic images subdivided (each) into four sub-images.

The sequence indicating the arrangement of the four sub images within the stereoscopic image is then inserted into the protocol, which sequence is adapted to transform into colour elements the information indicating whether the sub-images of the stereoscopic image have a side-by-side layout (vertical division of the stereoscopic image) or an up-down layout (horizontal division of the stereoscopic image). As previously described with reference to the protocol for stereoscopic images subdivided into two sub-images, a colour element, e.g. blue, identifies a horizontal division, whereas another colour element, e.g. red, identifies a vertical division.

At the end of the sequence indicating the arrangement of the four sub-images within the stereoscopic image, another white separator element is inserted into the protocol which precedes the sequence indicating the arrangement of the sub-images intended for the user's left eye relative to the sub-images intended for the user's right eye.

The sequence indicating the arrangement of the sub-images intended for the user's left eye relative to the sub-images intended for the user's right eye comprises four colour elements, still based on the convention according to which the red colour element is associated with the concept of what is located on the left and the green colour element is associated with the concept of what is located on the right.

In order to be able to establish which colour elements are to be inserted into the sequence indicating the arrangement of the sub-images intended for the user's left eye relative to the sub-images intended for the user's right eye, the system 18 performs a scan along an X axis or a Y axis, respectively, depending on the type of division detected. The X axis is parallel to a major side 56 of the stereoscopic image 47, whereas the Y axis is parallel to a minor side 57 of the stereoscopic image 47.

For horizontal division, the scan will take place from bottom to top along the Y axis; for vertical division, the scan will take place from left to right along the X axis. The sub-images found during the scan will determine the colour of the colour elements to be inserted into the protocol.

FIG. 3 shows a stereoscopic image 47 comprising:

a first upper sub-image 21 and a first lower sub-image 22, both of which are intended for the user's right eye and are arranged at the centre of the stereoscopic image 47, one on top of the other, so as to totally reproduce the image to be displayed;

a second upper sub-image 23, intended for the user's left eye and obtained by overturning the first upper sub-image 21 about an A axis parallel to the X axis;

a second lower sub-image 24, intended for the user's left eye and obtained by overturning the first lower sub-image 22 about a B axis parallel to the X axis.

In this case, since the stereoscopic image 47 has been divided horizontally, the four colour elements to be inserted are, in succession, a red colour element, a green colour element, a green colour element and a red colour element. This is because the scan carried out along the Y axis finds, in this order, the second lower sub-image 24 intended for the user's left eye (associated with the red colour element), the first lower sub-image 22 intended for the user's right eye (associated with the green colour element), the first upper sub-image 21 intended for the user's right eye (associated with the green colour element) and, finally, the second upper sub-image 23 intended for the user's left eye (associated with the red colour element).

At the end of the sequence indicating the arrangement of the sub-images intended for the user's left eye relative to those intended for the user's right eye, another white separator element is inserted into the protocol which precedes the sub-image rotation and/or reflection and/or overturning sequence.

The sub-image rotation and/or reflection and/or overturning sequence defines a sequence of colour elements that provide information useful for knowing if the sub-images are rotated and/or reflected and/or overturned relative to the stereoscopic image to be displayed.

By convention, it is established that the left side of the stereoscopic image corresponds to the red colour element, the right side corresponds to the green colour element, the upper side corresponds to the blue colour element, and the lower side corresponds to the black colour element.

In order to be able to establish which colours are to be inserted, it is necessary to carry out a double scan, first along the X axis and then along the Y axis, thus verifying which sides of the stereoscopic image to be displayed are referred to by the sides of the sub-images.

In the case of the stereoscopic image 47, eight colour elements will, have to be inserted in succession into the protocol based on the result of the scan along the X axis:

four red colour elements and four green colour elements.

This is because, starting from the lower left corner of the stereoscopic image 47 (starting point of the scan along the X axis), the following will be encountered in succession:

a left side 25 of the second lower sub-image 24, corresponding to the left side of the stereoscopic image to be displayed;

a left side 26 of the first lower sub-image 22, corresponding to the left side of the stereoscopic image to be displayed;

a left side 27 of the first upper sub-image 21, corresponding to the left side of the stereoscopic image to be displayed;

a left side 28 of the second upper sub-image 23, corresponding to the left side of the stereoscopic image to be displayed;

a right side 30 of the second lower sub-image 24, corresponding to the right side of the stereoscopic image to be displayed;

a right side 31 of the first lower sub-image 22, corresponding to the right side of the stereoscopic image to be displayed;

a right side 32 of the first upper sub-image 21, corresponding to the right side of the stereoscopic image to be displayed;

a right side 33 of the second upper sub-image 23, corresponding to the right side of the stereoscopic image to be displayed.

Subsequently, based on the result of the scan along the Y axis, the following sequence of colour element pairs (identified in succession by the respective colour) will be inserted into the protocol:

blue, black;

black, blue;

black, blue;

blue, black.

This is because the blue-black pair corresponds to an overturned image, while the black-blue pair corresponds to a non-overturned image.

In fact, starting from the bottom of the stereoscopic image 47, the second lower sub-image 24 is overturned, the first lower sub-image 22 is not overturned, the first upper sub-image 21 is not overturned, and the second upper sub-image 23 is overturned.

Consequently, because of the double scan performed, the sub-image rotation and/or reflection and/or overturning sequence comprises two sub-sequences, one for each scan and each consisting of four colour elements, separated by a white separator element.

A free portion sequence is then inserted into the protocol for possible further protocol expansions, at the end of which a white colour element is inserted. The free portion sequence may be used for new forms of encoding of the information for the two eyes and/or for data transmission in view of re-programming the decoding systems.

The protocol sequence ends with a protocol end identification sequence for a video stream containing stereoscopic images subdivided into four sub-images.

The protocol end identification sequence for a video stream containing stereoscopic images subdivided into four sub-images may be identical to the protocol start identification sequence for a video stream containing stereoscopic images subdivided into four sub-images.

A configuration like the one shown in FIG. 3 minimizes any visualization defects, i.e. the so-called “compression artifacts”, which may arise along the A axis parallel to the X axis, i.e. between the first upper sub-image 21 and the second upper sub-image 23, and/or along the B axis parallel to the X axis, i.e. between the first lower sub-image 22 and the second lower sub-image 24.

This type of configuration proves to be substantially compatible with a bidimensional visualization of stereoscopic images. This is attainable by masking the second upper sub-image 23 and the second lower sub-image 24, similarly to the method used for displaying films on 4:3 television sets.

Furthermore, this type of configuration makes the protocol also usable with non-stereoscopic 16:9 television sets. In such a case, it is necessary to enlarge the first upper sub-image 21 and the first lower sub-image 22 until the whole area having a 16:9 ratio is covered. If a satellite decoder is included in the reception system of the 16:9 television set, then the satellite decoder can be re-programmed to be able to recognise the protocol according to the invention and mask (with a black area) the second upper sub-image 23 and the second lower sub-image 24, just as it is already happening for films having a greater width/height ratio than the host image.

The spreading of videos encoded with the protocol according to the invention may take place through any of the means currently in use for distributing video streams containing bidimensional images: satellite, terrestrial radio links, cable or sale of prerecorded data media (e.g. DVD, Blu-Ray, etc.).

In another version, the second lower sub-image 24 and the second upper sub-image 23 may be exchanged.

The decoding means 14 comprise analog and/or digital input circuit means 11, which can be connected to the possible video stream sources, image processing means 12, and output stereoscopic image formatting means 13, which can be connected to a display device 16, e.g. a stereoscopic television set.

The decoding means 14 are thus connected on one side to the possible video stream sources through the input circuit means 11 and on the other side to the display device 16.

In particular, with reference to the example of FIG. 1, the. decoding means 14 are inserted between the transmission means 19, which supply them with the video stream containing stereoscopic images, and the display device 16 on which the images are reproduced.

The image processing means 12 are provided with push-buttons 6, 7 which enable different operating modes.

The image processing means 12 are also equipped with a switch 8 that enables different operating sub-modes pertaining to stereoscopic and/or bidimensional vision. A first sub-mode allows the protocol, if present in the input video stream, to be decoded automatically. The switch 8 can be operated to enable either stereoscopic vision or bidimensional vision, in the latter case enlarging only a portion of the sub-images contained in the input flow on the display device 16.

In this example of automatic operation, the image processing means recognise the presence or absence of the protocol within the image and operate the switch in order to enable either bidimensional or stereoscopic vision.

Furthermore, in the case of stereoscopic vision, the processing means 12 recognise the configuration of the sub-images for the right eye and for the left eye, and then extract both sub-images, storing them in specific memory areas; in this manner, the sub-images can be re-combined, if necessary, by the formatting means 13, which will be described more in detail below.

The switch 8 may be comprised in a remote control used for controlling different audio/video functions of the display device 16.

In a version not shown in the drawings, the decoding means 14 may be built in the display device 16 or in satellite receivers or the like (like, for example, the receiver 2).

In the example of FIG. 1, the decoding means 14 additionally comprise a screen 15 which can be connected to the image processing means 12.

The screen 15 allows a user to see which operating mode is enabled, e.g. automatic or manual decoding, stereoscopic or bidimensional visualization, enabled stereoscopic encoding type.

By checking on the screen 15 which is the selected mode, it will be possible to enable further decoding modes through the push-buttons 6 and 7. For example, it will be possible to enable the most common stereoscopic encoding types (up-down, side by side or interlaced). Thus, video streams coming from DVDs or from the Internet and lacking the protocol according to the invention can be decoded as well.

In practice, by using the push-buttons 6 and 7 it is possible to provide the image processing means with the information about the type of stereoscopic encoding of the video stream received.

Again, by operating the switch 8 it will be possible to enable or disable stereoscopic vision.

The output stereoscopic image formatting means 13 are fitted with additional push-buttons 9, 10 which enable various stereoscopic image display modes.

The output stereoscopic image formatting means 13 allow to connect different types of tridimensional display devices 16; by verifying the selected mode on the screen, the user can enable the most widespread stereoscopic encodings through the other push-buttons 9 and 10. The available modes are the following: interlacing on horizontal lines (adopted, in particular, by micropolarization LCD television sets), interlacing on vertical lines (used in tridimensional plasma television sets), checkered (used in tridimensional back-projection DLP television sets, in plasma television sets and in some stereoscopic image projection systems using a single DLP projector), and dual video output, for connecting, for example, to two video projectors with polarizer filters for projection of stereoscopic images onto metallized screens or for back-projection on polarization holding screens.

When a display device or a stereoscopic image visualization mode is selected through the push-buttons 9 and 10, the formatting means will arrange the sub-images for the right eye and for the left eye according to a format compatible with the visualization mode selected or required by the display device.

As a whole, therefore, the image processing means 12 recognise the configuration of the sub-images in the stereoscopic image, extract them and make them available to the formatting means which, based on the selection made by the user through the push-buttons 9 and 10, then re-compose the sub-images into a stereoscopic image in accordance with the stereoscopic encoding required by the display device; this latter encoding may be different from that of the stereoscopic image contained in the video stream received from the input circuit means 11.

In other words, the decoding means 14 carry out a conversion from a first stereoscopic encoding to a second stereoscopic encoding, which conversion may be either automatic due to the code (or protocol) embedded into the image by the encoding means 20 or made possible on the basis of the information provided by the user through the push-buttons 6, 7, 9 and 10.

Although the invention has been described above with reference to the examples of FIGS. 1-3, it is clear that many changes may be made to the above-described stereoscopic image encoding and decoding method by those skilled in the art without departing from the protection scope of the present invention as set out in the appended claims.

In particular, as aforementioned, the decoding means 14 may be integrated into the display device 16; in such a case, the formatting means will know the nature of the display device 16 and will therefore be able to format the output stereoscopic image accordingly. In this case, the push-buttons 8 and 9 are not required.

Even though they are not built in the display device, the decoding means 14 may be programmed to output a stereoscopic image having a predefined format; in such a case, the decoding means 14 will receive a stereoscopic image wherein the sub-images are configured according to a first encoding, recognise the sub-image configuration, and convert the received stereoscopic image into the preset format (i.e. arrange the sub-images of the received stereoscopic image according to the predefined configuration); in particular, the conversion will take place automatically based on the protocol embedded into the image by the encoding means.

Furthermore, although in the preferred example previously described the information embedded into the stereoscopic image by the encoding means are arranged according to a chromatic sequence having a protocol (code) start sequence and end sequence, it is apparent that such information may bet arranged according to a different sequence and may not include a protocol start sequence and a protocol end sequence; in particular, the protocol start sequence may be omitted by defining a preset position of the chromatic code within the stereoscopic image; the decoding means will thus know beforehand where the chromatic code that supplies the information about the arrangement of the sub-images in the stereoscopic image starts.

In order to reduce the risk that a bidimensional image has colours which might be interpreted as a chromatic code indicating the arrangement of the sub-images in a stereoscopic image, it is conceivable to increase the length of the chromatic code.

Furthermore, it is apparent that the video stream comprising stereoscopic images with the protocol described herein may be stored as data into any type of mass memory, i.e. an optical, magnetic, magnetic-optical, solid-state medium or the like.

Said mass memory will thus comprise data sequences representing said video stream.

1. System for decoding stereoscopic images carried in a single video stream, wherein a stereoscopic image carried by said video stream comprises at least two sub-images arranged according to a first configuration and intended respectively for a user's right eye and left eye,
characterized by comprising decoding means (14) adapted to receive said stereoscopic image,
recognise said first configuration of said at least two sub-images based on information embedded into said stereoscopic image, and
arrange said at least two sub-images according to a second predetermined configuration.

2. System according to claim 1, wherein said information is relative to a mutual arrangement of said at least two sub-images comprised in said stereoscopic image.

3. System according to claim 1, wherein said information indicates a rotation and/or reflection and/or overturning of at least one group of said at least two sub-images.

4. System according to claim 1, wherein said information is encoded as a chromatic code.

5. System according to claim 4, wherein said code comprises a plurality of sequences of chromatic elements associated with different pieces of said information, and wherein said chromatic elements are arranged in a manner such that a preceding chromatic element and a chromatic element immediately following it have different colours.

6. System according to claim 5, wherein two consecutive sequences of said sequences of chromatic elements are separated by a white colour element.

7. System according to claim 4, wherein said code comprises a plurality of mutually alternated chromatic elements, said chromatic elements comprising colour elements and basic elements, wherein the basic elements are interposed between the colour elements, and wherein the width of the chromatic elements is correlated to the horizontal width of the stereoscopic image.

8. System according to claim 7, wherein said code has a length equal to one line of the stereoscopic image.

9. System according to claim 7, wherein the width of one of said basic elements is obtained by dividing the total width of the stereoscopic image by a predetermined number, in particular by 128, and wherein the width of each colour element is a whole multiple of, in particular twice as, the length of the basic elements.

10. System according to claim 4, wherein said code is arranged near upper and/or lower areas of said stereoscopic images.

11. System according to claim 1, wherein said decoding means comprise selection means (8,9), in particular push-buttons, for allowing a user to select said second configuration.

12. System according to claim 1, wherein said decoding means (14) are built in or connected to a display device (16), and wherein said second predetermined configuration ensures a correct visualization on said display means.

13. System according to claim 1, wherein said decoding means (14) can also receive and transmit a video stream of bidimensional images.

14. System according to claim 1, wherein said decoding means (14) comprise means (6,7), in particular push-buttons, through which a user can provide the image processing means with information about the type of stereoscopic encoding of the video stream received by said image processing means.

15. System for encoding a stereoscopic image, wherein a stereoscopic image comprises at least two sub-images arranged according to a first configuration and intended respectively for a user's right eye and left eye,
characterized by comprising encoding means (20) adapted to embed into a stereoscopic image a code adapted to provide information about said first configuration.

16. System according to claim 15, wherein said code is a chromatic code.

17. System according to claim 15, wherein said information is about a mutual arrangement of said at least two sub-images comprised in said stereoscopic image.

18. System according to claim 15, wherein said information indicates a rotation and/or reflection and/or overturning of at least one group of said at least two sub-images.

19. System according to claim 15, wherein said code comprises a plurality of sequences of chromatic elements associated with different pieces of said information, and wherein said chromatic elements are arranged in a manner such that a preceding chromatic element and a chromatic element immediately following it have different colours.

20. System according to claim 19, wherein two consecutive sequences of said plurality of sequences of chromatic elements are separated by a white colour element.

21. System according to claim 15, wherein said code comprises a plurality of mutually alternated chromatic elements, said chromatic elements comprising colour elements and basic elements, wherein the basic elements are interposed between the colour elements, and wherein the width of the chromatic elements is correlated to the horizontal width of the stereoscopic image.

22. System according to claim 21, wherein said code has a length equal to one line of the stereoscopic image.

23. System according to claim 21, wherein the width of one of said basic elements is obtained by dividing the total width of the stereoscopic image by a predetermined number, in particular by 128, and wherein the width of each colour element is a whole multiple of, in particular twice as, the length of the basic elements.

24. System according to claim 15, wherein said code is arranged near upper and/or lower areas of said stereoscopic images.

25. Method for decoding stereoscopic images, wherein
a video stream comprising a stereoscopic image is received, said stereoscopic image comprising at least two sub-images arranged according to a first configuration and intended respectively for a user's right eye and left eye, characterized in that
said first configuration of said at least two sub-images is recognised based on information embedded into said stereoscopic image,
the sub-images of the received stereoscopic image are arranged according to a second predetermined configuration.

26. Method according to claim 25, wherein said predetermined configuration is selected by the user.

27. Method according to claim 25, wherein said two sub-images are recognised on the basis of a chromatic code.

28. Method according to claim 25, wherein at least one, but preferably all, of said at least two sub-images is/are extracted.

29. Method according to claim 25, wherein said information is about a mutual arrangement of said at least two sub-images.

30. Method according to claim 25, wherein said information indicates a rotation and/or reflection and/or overturning of at least one group of said at least two sub-images.

31. Method according to claim 25, wherein in the absence of said information in the stereoscopic image, said first configuration is defined by a user.

32. Method for encoding stereoscopic images, wherein
a stereoscopic image comprises at least two sub-images arranged according to a first configuration and intended respectively for a user's right eye and left eye,
characterized in that a code is embedded into said stereoscopic image, which code is adapted to provide information about said configuration.

33. Method according to claim 32, wherein said code is a chromatic code.

34. Method according to claim 32, wherein said information is about a mutual arrangement of said at least two sub-images comprised in said stereoscopic images.

35. Method according to claim 32, wherein said information indicates a rotation and/or reflection and/or overturning of at least one group of said at least two sub-images.

36. Method according to claim 32, wherein said code comprises a plurality of sequences of chromatic elements associated with different pieces of said information, and wherein said chromatic elements are arranged in a manner such that a preceding chromatic element and a chromatic element immediately following it have different colours.

37. Method according to claim 36, wherein two consecutive sequences of said plurality of sequences of chromatic elements are separated by a white colour element.

38. Method according to claim 32, wherein said code comprises a plurality of mutually alternated chromatic elements, said chromatic elements comprising colour elements and basic elements, wherein the basic elements are interposed between the colour elements, and wherein the width of the chromatic elements is correlated to the horizontal width of the stereoscopic image.

39. Method according to claim 38, wherein said code has a length equal to one line of the stereoscopic image.

40. Method according to claim 37, wherein the width of one of said basic elements is obtained by dividing the total width of the stereoscopic image by a predetermined number, in particular by 128, and wherein the width of each colour element is a whole multiple of, in particular twice as, the length of the basic elements.

41. Method according to claim 32, wherein said code is arranged near upper and/or lower areas of said stereoscopic images.

42. Video stream comprising at least one stereoscopic image, characterized in that said stereoscopic image is encoded by using the method according to claim 31.

43. Mass memory characterized by comprising data sequences representing a video stream according to claim 42.
